(19) United States
(12) Patent Application Publication
(10) Pub. No.: US 2023/0180734 A1
(43) Pub. Date: Jun. 15, 2023

(54) MULTI-ZONE HORSESHOE PAD

(71) Applicant: Bartek Equine LLC, Burlington, WI (US)

(72) Inventor: Bart Halsberghe, Knesselare (BE)

(21) Appl. No.: 18/082,197

(22) Filed: Dec. 15, 2022

Related U.S. Application Data
(60) Provisional application No. 63/289,937, filed on Dec. 15, 2021.

(51) Int. Cl. A01L 7/02

(52) U.S. Cl. CPC A01L 7/02

(57) ABSTRACT

A multi-zone horseshoe pad that provides hybrid performance characteristics, with discrete performance characteristics provided during discrete phases or different types of interactions between a hoof and the ground. The multi-zone horseshoe pad is substantially flexible while also providing shock absorption, protection, and support. The multi-zone horseshoe pad may include a pad body with different segments that have different hardness values. A relatively softer material may be provided toward a back segment of the pad body for shock absorption and vibration damping during impacts between the horseshoe and hoof at the pad's back segment. A relatively harder material may be provided toward a front segment of the pad body for minimizing energy loss through compression during push off events at the pad's front segment. A central segment of the multi-zone horseshoe pad may be both thicker and more flexible than an outer rim segment.

### CROSS-REFERENCE TO RELATED APPLCIATION

This application claims the benefit of and priority to U.S. Provisional Patent Application Ser. No. 63/289,937, filed Dec. 15, 2021, entitled “Multi-Zone Horseshoe Pad,” the contents of which are incorporated herein by reference in their entirety.

### FIELD OF THE INVENTION

The present invention relates to horse hoof-related devices and, more particularly, to a multi-zone horseshoe pad that provides hybrid performance characteristics, with different performance characteristics provided for different parts of a hoof.

### BACKGROUND OF THE INVENTION

Hoof pads or horseshoe pads are implemented on some shod horses as a structure that is sandwiched between the hoof and horseshoe. There are numerous situations in which horseshoe pads can provide benefits over horseshoes alone. These may include providing protection from puncture or other traumas, impact relief, shock absorption, support, pressure relief, conformational correction, or correction of other hoof/limb-related medical problems.

Along with the numerous reasons to implement horseshoe pads, there are numerous different horseshoe pad configurations. Typically, a horseshoe pad's form will be configured to address a specific one of the implementation reasons. Others may address more than one implementation reason, typically as a compromise of each, when compared to the more singularly-purpose configured versions. Typically a horseshoe pad is between 3 and 5 millimeters thick to provide sufficient shock absorption and protection. The typical horse shoe pad consists of one or two segments. In the two-segment configuration, defining an outer rim segment and a central segment, the outer rim segment is typically equal to or thicker than the central segment as the main function of the outer rim is shock absorption and impact relief The central segment is typically an uninterrupted layer, as the main function of the central segment is to protect the sole and frog and/or provide support. The central segment may have a certain number of holes or valves that function as access points to inject silicone or another polymer underneath the horseshoe pad to provide additional support. A mesh-type central segment is sometimes used, in this configuration the main purpose of the mesh (and horseshoe pad) is to hold hoof packing material in place for the duration of the shoeing cycle.

Furthermore, there have been advancements in horseshoe technologies that present challenges when implementing known horseshoe pad technologies. An example is a dividable horseshoe, available under the trade name TWIN™ Shoe from Bartek Equine LLC, that can be converted from a one-piece horseshoe into a two-piece horseshoe during a horse shoeing procedure, with the two-piece horseshoe allowing a horse's hoof mechanism to function properly e.g., resiliently flex, substantially similar to a barefoot hoof. However, typical horseshoe pads may limit such a two-piece horseshoe's ability to accommodate the hoof's cyclical resilient or visco-elastic three-dimensional self-reversing deformation.

### SUMMARY OF THE INVENTION

The invention provides a multi-zone horseshoe pad that provides hybrid performance characteristics, with different performance characteristics provided for different parts of a hoof and which can be divided at a dividable transition zone which if divided supports a two-piece horseshoe's ability to accommodate the hoof's cyclical resilient or visco-elastic three-dimensional self-reversing deformation. Part of the pad is configured for shock absorption and another part of the pad is configured for force transfer efficiency. The pad also allows for stretch and recoil to adjust to the visco-elastic three-dimensional self-reversing deformation of the hoof, that takes place during cyclical loading. The multi-zone horseshoe pad may include a pad body with different segments that have different hardness values. A relatively softer material may be provided toward a back segment of the pad body for shock absorption and vibration damping during impacts between the horseshoe and hoof at the pad's back segment. A relatively harder material may be provided toward a front segment of the pad body for minimizing energy loss through compression during push off events at the pad's front segment.

In accordance with another aspect of the invention, the multi-zone horseshoe pad may have one or more transition zones between a front segment of the pad body and a back segment of the pad body whereby the transition zones have different hardness values than a front and a back segment.

In accordance with another aspect of the invention, the multi-zone horseshoe pad has segments with sufficiently flexibility to allow for natural hoof shape deformations and restorations. This may be especially enhanced when implemented with two-piece horseshoes.

In accordance with another aspect of the invention, the multi-zone horseshoe pad may include a central segment that is more flexible than an outer rim segment. This provides a pad with substantial flexibility while also providing shock absorption, protection, and support. The central segment may be both thicker and more flexible than the outer rim segment, with the central segment providing the most flexible portion of the pad in some implementations.

In accordance with another aspect of the invention, the flexibility/stretchability of the pad freely allows the natural hoof mechanism to function with an emphasis on hoof expansion during impact and loading and lateral flexibility of the hoof capsule on uneven ground. Furthermore, the flexibility/stretchability of the pad accommodates hoof growth between two shoeing cycles, which leads to spreading of the hoof due to its cone shaped structure of up to, for example, 10 mm in width.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a perspective view of an illustration of a multi-zone horseshoe pad according to an aspect of the present disclosure;

FIG. 2 is an illustration of a multi-zone horeshoe pad having side transition zones according to another aspect of the present disclosure;

FIG. 3 is an illustration of a mult-zone horseshoe pad having a mesh-like or grid-like central segment according to a further aspect of the present disclosure; and

FIG. 4 is an illustration of a mult-zone horseshoe pad having a multi-zone central segment according to a still further aspect of the present disclosure.

### DETAILED DESCRIPTION

Those of ordinary skill in the art of horseshoes, shoeing, and associated pads (including farrriers) will appreciate that the terms herein may refer to various conventional parts of a shoe or horse. Terms that include terms such as toe, hoof, sole, and frog refer to parts of the horse's anatomy that those skilled in the art will appreciate what those are and where they are on a horse or ungulate.

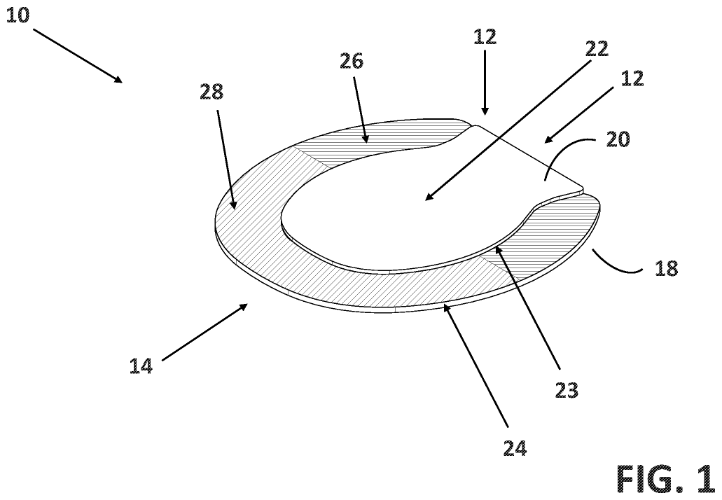

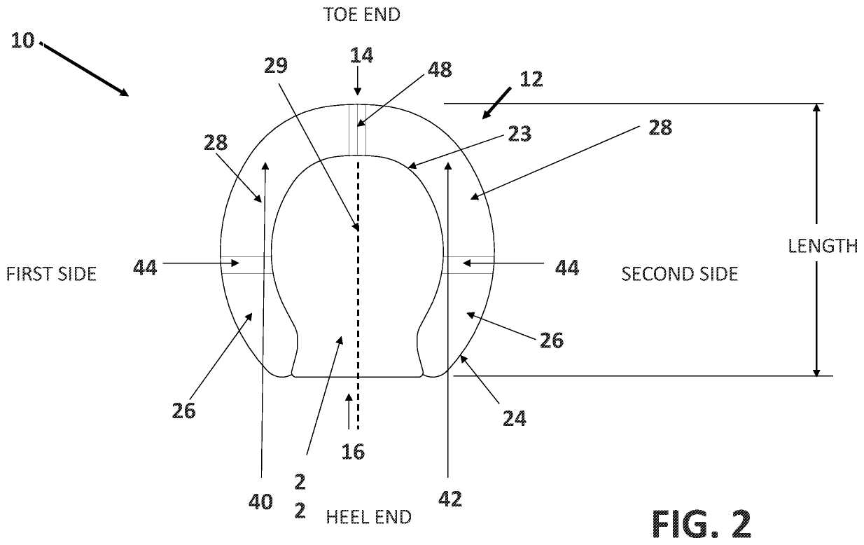

Referring now to FIG. 1, a multi-zone horse pad is shown here as a pad 10. The pad 10 includes a pad body 12 that has different portions or segments that offer different performance characteristics. The pad body 12 has a length defined longitudinally along its centerline 29 (shown in FIG. 2), between a toe end 14 at the shoe's front end and a heel end 16 at the shoe's back (heel) end and a width that is perpendicular to the centerline 29. A thickness dimension(s) is defined at different portions or segments of the pad body 12, between a hoof-engaging or hoof-facing upper surface 18 (shown facing down relative to page) and an opposite or opposing horseshoe-facing or ground-facing lower surface 20 (shown facing up relative to the page).

Still referring to FIG. 1, the pad body 12 has a central segment 22 at its intermediate portion and an outer rim segment 24 that is arranged outwardly of the central segment 22. The outer rim segment 24 defines at least a portion of an outer perimeter 23 of the pad body 12 and is shown here with a generally U-shaped or horseshoe-shaped form. The central segment 22 and the outer rim segment 24 are typically different thickness dimensions, shown here with a thicker central segment 22. Although the central segment 22 may have the same thickness as the outer rim segment 24, it is typically between 25% thicker and up to about 5-times or 6-times or 7-times thicker than the outer rim segment 24. More typically, the outer rim segment 24 has a thickness of between 1 mm and 3 mm and the central segment 22 has a thickness of between 1 mm and 7 mm Most typically, the outer rim segment 24 has a thickness of between 1 mm and 2 mm and the central segment 22 has a thickness of between 3 mm and 5 mm. The differences in thickness provide different performance characteristics in correspondingly different zones of the pad 10.

According to aspects of the present disclosure, up to four, or five, or six, or seven, or more than seven distinct zones (inclusive of transition zones) as described herein can be provided relative to the pad 10, which have differing hardness and permit different flexing and movement relative to other zones. An example of a zone occurs where there is a difference in hardness from one side of the zone to the other side. Where the hardness difference occurs defines a zone transition in some aspects of the present disclosure. The zone transition can occur abruptly, such as a sudden change in hardness from one side to the other side of the zone, or can occur gradually over a distance or area. The zone can represent an area spanning an entire distance between an inner and outer circumference of the outer rim segment 24. In some implementations, at least one pair of immediately adjacent (abutting) zones have differing hardnesses relative to one another, or at least two pairs of immediately adjacent (abutting) zones have differing hardness relative to one another. In some implementations, in all of the zones relative to the pad 10, there are at least two or at least three or at least four or at least five different hardness values present. The entire outer rim segment 24 can be after manufacturing in its ready-to-mount form a singular, integral piece (before optional cutting of the toe transition zone 48 seen in FIG. 2) with different hardness values represented among the various zones present on the pad 10.

Still referring to FIG. 1, besides different performance characteristics and zones that correspond to different segment or portion dimensions, various discrete zones (as discussed above) can be defined within the same segment, even different portions of a segment with a common dimension(s). This is shown within the outer rim segment 24, with first and second zones shown as impact zone 26 and loading and push off zone 28, with different hardness values. Those skilled in the art to which the present disclosure pertains will understand the mechanics of an ungulate's stride and where the hoof impacts the ground versus undergoes a loading when pushing off the ground. The terms “impact” and “loading and push off” will be familiar to those skilled in the art of shoeing ungulates such as horses. The impact zone 26 is provided at the pad body's heel (back, opposite the toe) end 16 and defines a first hardness value. The hardness value of the impact zone 26 is typically less than that of the loading and push off zone 28 and is sufficiently compliant to provide shock absorption and vibration damping during impacts between the horseshoe and hoof at the pad's back segment. This is typically achieved by forming the impact zone 26 from a material that provides a hardness value of about (plus or minus 30%) 45 shore D hardness. The loading and push off zone 28 is provided at the pad body's toe end 14 opposite the heel end 16 and defines a second hardness value. The hardness value of the loading and push off zone 28 is typically greater than that of the impact zone 26 and is sufficiently rigid to provide resistance to compression and reduce or minimize energy loss through compression or other material deformation during push off events at the pad's toe end 14. This is typically achieved by forming the loading and push off zone 28 from a material that provides a hardness value of about (plus or minus 30%) 60 shore D hardness.

Regardless of the particular hardness values, the impact zone 26 is shown here as shorter or occupies less of the overall pad body length (shown in FIG. 2) than the loading and push off zone 28. Typically, the impact zone 26 will occupy between about 35% to 50% and the loading, and the push off zone 28 will occupy between about 65% and 50% of the pad body's overall length. More typically, the impact zone 26 will occupy between about 40% to 45%, and the loading zone 28 will occupy between about 60% and 55% of the pad body's overall length. In at least some versions, the impact zone 26 and the loading and push off zone 28 can have at least nominally common width dimensions. In an implementation in a large-sized pad 10 (e.g., used with horseshoes between the sizes 2 to 4) with an examplary pad length of 165 mm and an exemplary pad width of 165 mm, the entire outer rim segment 24 can have an examplary width of 35 mm In other applications, the width of outer rim segment 24 typically scales with those other sizes, for example, based on 10 mm margins, such as a medium sized pad 10 (e.g., used with horseshoes between the sizes 0 to 2) will typically have a pad length of 153 mm and a pad width of 153 mm, and a small sized pad 10 (e.g., used with horseshoes between the sizes 00 to 0) will typically have a pad length of 141 mm and a pad width of 141 mm.

Referring now to FIG. 2, the outer rim segment 24 defines multiple portions, such as a first outer rim leg 40 arranged at a first side of the pad body 12 and a second outer rim leg 42 arranged at a second side of the pad body 12. Each of the first and second outer rim legs 40, 42 has a corresponding impact zone 26 and a loading and push off zone 28, which are aligned with each other along the pad body's length but at opposites sides of the pad body 12. The transition zones are shown as side transition zones 44 (extending the entire dstance between the inner and outer circumference of the outer rim segment 24) between the respective impact zone 26 and the loading and push off zone 28. In the transition zones 44, the hardness of the outer rim segment 24 transitions (abruptly or gradually across a gradient) from the harder value of loading and push off zone 28 to the softer value of impact zone 26. Transition zones 44 can have a hardness value which is similar or substantially equal to (e.g., within ±5%) a hardness value of the impact zones 26 or to hardness values of the loading and push off zones 28 or of the transition zones 44 can have a hardness value which is higher than a hardness value of the impact zones 26 and lower than a hardness values of the loading and push off zones 28. To provide optimum flexibility and stretchability, the hardness of the transition zones 44 can even be set lower than the hardness of the adjance impact zones 26.

Still Referring to FIG. 2, besides the transition zones 44, there is a toe transition zone 48 providing a transition between and defining a dividable connection structure between forward ends of the outer rim legs 40, 42. In an implementation of the pad 10 in combination with a dividable horseshoe (not shown) such as available under the trade name TWIN™ Shoe from Bartek Equine LLC, during a horseshoeing procedure in which a one-piece horseshoe is converted into a two-piece horseshoe, the toe transition zone 48 can be cut or divided into two to provide a kerf-type void space that is aligned with a separation space at the toe of the two-piece horseshoe. In another version used with the dividable horseshoe, instead of configuring the toe transition zone 48 to be cut during the one-piece to two-piece horseshoe conversion, the toe transition zone 48 can be configured to remain intact but be sufficiently stretchy, for example, made from an elastomeric material or a softer polyurethane or other polymeric material, to provide sufficient flexing capacity to allow for articulation of the toe ends of the two-piece horseshoe with respect to each other. Both in a cut configuration as in an intact stretchy configuration, the toe transition zone 48 allows for unrestricted growth of the horse's hoof wall. In order to provide optimum flexibility and stretchability the hardness of the toe transition zone 48 can be set lower than the hardness of the loading and push off zones 28 or even lower than the hardness of the impact zones 26.

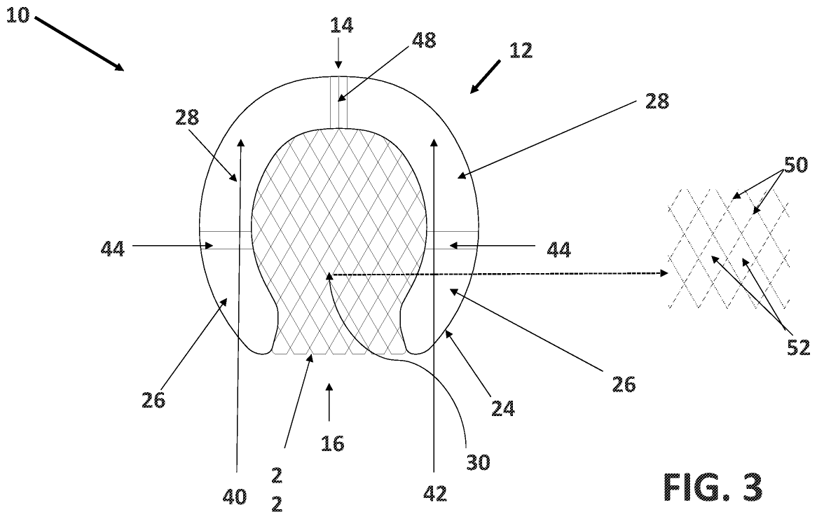

Referring now to FIG. 3, besides the different zones such as the impact zone 26 and the loading and push off zone 28 within the outer rim segment 24, the central segment 22 can define another zone with different performance characteristics, represented as a central flex zone 30. The central flex zone 30 is provided at the pad body's central segment 22 and is typically both thicker and more flexible than the outer rim segment 24.

The central flex zone 30 can define at least a third hardness value. The hardness value of the central flex zone 30 is typically less than those of both the impact zone 26 and the loading and push off zone 28, can define the most flexible portion of pad 10, and is sufficiently compliant to allow for its flexing, stretching, and restoring movement in multiple directions to accommodate natural hoof shape deformations and restorations during a horse hoof's weight-bearing stance phase(s) and gait-induced load(s). This is typically achieved by forming the central flex zone 30 from a material that provides a hardness value of about (plus or minus 30%) 30 shore D hardness. To achieve the desired hardness values, the components or segments of pad 10 are typically made from a polymeric material(s), more typically a polyurethane and may also or instead include various elastomeric or polymeric materials, such as various ones of the D30® materials from the D30 Lab in the United Kingdom. Different materials or material characteristics can be provided by, for example, over-molding and/or other molding procedures that can include corresponding bonding procedures to implement multiple materials. Based on a particular horse hoof's sole quality and hardness and an amount of required and/or tolerated amount of support versus protection, a silicone filling material, typically with a density or hardness of between 20 to 40 shore A, can be applied to fill the area between the pad 10 and the hoof's sole surface.

Still referring to FIG. 3, besides material characteristics, the flexibility of the central flex zone 30 can instead be defined by or be further afforded by flex-enhancing features, which can include various void spaces, such as internal voids or, more typically, surface-exposed voids that may provide a discontinuous surface at the flex zone 30. These flex-enhancing features can have different shape patterns depending on the degree of flexibility versus rigidity that is needed to accommodate the individual hoof characteristics. An example of a typical used pattern is a diamond shape pattern. An example of a discontinuous surface at flex zone 30 is shown here provided by various negative space(s) and positive structure(s). The positive structures in this example are provided by a matrix of intersecting raised ribs 50. The negative spaces are provided by a pattern of diamond-shaped pockets 52 between the intersecting ribs 50. Pockets 52 present openings which are either open at the ground facing lower surface 20 (FIG. 3) of pad body 12 and include bottom walls defined at a continuous solid surface of the hoof-facing upper surface 18 (FIG. 3) of pad body 12 or vice versa openings which are open at the hoof-facing upper surface 18 (FIG. 3) of pad body 12 and include bottom walls defined at a continuous solid surface of the ground facing lower surface 20 (FIG. 3).

Besides the more flexible material in the central flex zone 30, its substantial amount of void space per area provided by pockets 52 allows the flex zone 30 to be more flexible than if the flex zone 30 had a solid configuration. At least some of the pockets 52 and the ribs 50 can define a repeating geometric pattern that facilitates flexing of the central segment in multiple directions. All of the pockets 52 can have a common shape and size, shown here as a repeating pattern of commonly sized and shaped adjacent diamond-shaped pockets 52. Note that the shape and size of the flex-enhancing features can change throughout the central segment depending on the degree of flexibility needed in a particular area of the central segment. The dimensions of the pockets 52 are typically substantially smaller than overall dimensions of pad 10, such as between 0.5% to 5%. In one implementation, the overall dimensions of pad 10 are 165 mm (length×165 mm (width) and pockets 52 are implemented with elongate diamond configurations of 2 mm (length)×1.33 mm (width).

In another version, the negative space(s) and positive structure(s) of the central segment's flex-enhancing features are reversed. In such a reversed example, instead of ribs 50 and pockets 52, flex channels can provide living hinges as slits or other depressions that extend into the central segment 22, typically into the ground-facing lower surface 20 (FIG. 1) of the pad body 12. Such flex channels can be configured to accommodate flexing of the central segment 22 by providing lines of weakness compared to the rest of the central segment 22. The other portions of the central segment 22 that are adjacent the flex channels can define protuberances between the reduced-thickness flex channels. The protuberances can pivot toward or away from each other about pivot axes that are defined by the flex channels during flexing of the central segment 22. In yet another version, instead of the pockets 52 with bottom or ceiling walls, through-holes are defined between the ribs 50. This provides a mesh configuration to the central flex zone 30.

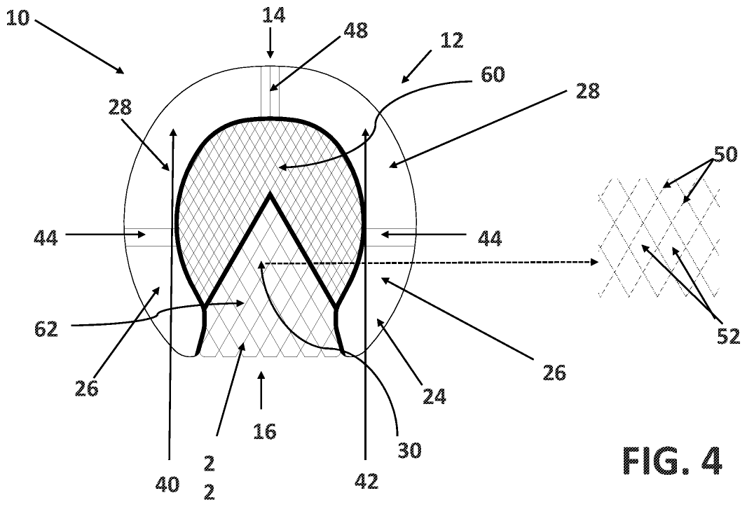

Referring now to FIG. 4, this implementation shows multiple zones within the central segment 22. The central segment 22 is shown here with a central sole segment 60 toward the toe end 14 and a central frog segment 62 toward the heel end 16, which have different hardness values. The central frog segment 62 has a generally triangular form or perimeter shape that extends into the central sole segment 60 and is configured to overlay a hoof's frog. Typically, the central sole segment 60 has a hardness value that is greater than that of the central frog segment 62, for example, at least twice the hardness. This hardness differential within the central segment 22 can be provided by a central sole segment 60 with a hardness value of 30 shore D hardness and a central frog segment 62 with a hardness value of 10 shore D harness, sufficiently low to allow a hoof's frog to perceptibly feel through the thickness of the central frog segment 62. However, in some applications, depending on the underlying hoof problem, the central sole segment 60 can have a hardness value that is lower than that of the central frog segment 62, for example, at least 20% less than the hardness of the central frog segment 62.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

As indicated above, many changes and modifications may be made to the present invention without departing from the spirit thereof The scope of some of these changes is discussed above. The scope of others is apparent from the appended claims.

1. A multi-zone horseshoe pad for implementation between a horseshoe and a horse hoof, the multi-zone horseshoe pad comprising:
a pad body that includes:
a central segment;
an outer rim segment arranged outwardly of the central segment and defining at least a portion of an outer perimeter of the pad body, wherein the outer rim segment includes:
an impact zone provided at a heel end of the pad body and defining a first hardness value;
a loading and push off zone provided at a toe end of the pad body and defining a second hardness value that is equal or greater than the first hardness value; and
a central toe transition zone.

2. The multi-zone horseshoe pad of claim 1 wherein the outer rim segment includes:
a first outer rim leg arranged at a first side of the pad body;
a second outer rim leg arranged at a second side of the pad body opposite the first side;
wherein each of the first and second outer rim legs includes an impact zone and a loading and push off zone.

3. The multi-zone horseshoe pad of claim 2 wherein each of the first and second outer rim legs further includes:
a side transition zone between the respective impact zone and loading and push off zone.

4. The multi-zone horseshoe pad of claim 3 wherein at the transition zone in each of the first and second outer rim legs, the respective outer rim leg transitions from the first hardness value to the second hardness value.

5. The multi-zone horseshoe pad of claim 4 wherein the transition zones in each of the first and second outer rim legs, have a hardness value which is substantially the same as or equal to a hardness value of the impact zones or to a hardness values of the loading and push off zones.

6. (canceled)

7. The multi-zone horseshoe pad of claim 4 wherein the transition zones in each of the first and second outer rim legs, have a hardness value which is lower than a hardness values of the impact zones.

8. The multi-zone horseshoe pad of claim 1 wherein the toe transition zones has a hardness value which is equal or lower than a hardness values of the impact zones.

9. (canceled)

10. The multi-zone horseshoe pad of claim 4 wherein:
the pad body defines a length between a toe end and a heel end of the pad body;
the transition zone is located closer to the heel end than the toe end.

11. The multi-zone horseshoe pad of claim 5 wherein the transition zone is located between 40% to 70% along the length of the respective outer rim leg as measured from the toe end of the pad.

12. The multi-zone horseshoe pad of claim 1 wherein:
the central segment defines a central thickness dimension; and
the outer rim segment defines an outer rim thickness dimension that is equal to or less than the central thickness dimension.

13. (canceled)

14. The multi-zone horseshoe pad of claim 1 wherein the central segment comprises a matrix of intersecting ribs that define pockets between a hoof-engaging or hoof-facing upper surface and an opposite horseshoe-facing or ground-facing lower surface with an uninterrupted surface at any level between a hoof-engaging or hoof-facing upper surface and an opposite horseshoe-facing or ground-facing lower surface.

15. The multi-zone horseshoe pad of claim 1 wherein the central segment comprises a matrix of intersecting ribs that define through holes between a hoof-engaging or hoof-facing upper surface and an opposite horseshoe-facing or ground-facing lower surface providing a mesh configuration to the central flex zone.

16. The multi-zone horseshoe pad of claim 1 wherein the central segment comprises flex channels configured to accommodate flexing of the central segment.

17. The multi-zone horseshoe pad of claim 16 wherein the central segment comprises protuberances defined between the flex channels so that the protuberances of the central segment pivot toward or away from each other about pivot axes defined by the flex channels during flexing of the central segment.

18. The multi-zone horseshoe pad of claim 16 wherein at least some of the protuberances and the flex channels define a repeating geometric pattern that facilitates flexing of the central segment in multiple directions.

19. The multi-zone horseshoe pad of claim 18 wherein the repeating geometric pattern is defined by adjacent protuberances with diamond shapes, rectangular shapes, or triangular shapes.

20. The multi-zone horseshoe pad of claim 1 wherein the central segment includes:
a central sole segment; and
a central frog segment,
wherein the central sole segment and the central frog segment have different hardness values.

21. (canceled)

22. (canceled)

23. A multi-zone horseshoe pad for implementation between a horseshoe and a horse hoof, the multi-zone horseshoe pad comprising:
a pad body that includes:
an impact zone provided at a heal end of the pad body and defining a first hardness value; and
a loading zone provided at a toe end of the pad body and defining a second hardness value that is equal or greater than the first hardness value.

24. The multi-zone horseshoe pad of claim 1 having at least six distinct zones including the central toe transition zone, the impact zone, and the loading and push off zone, such that at least two adjacent zone pairs of the at least six distinct zones have different hardness values relative to one another.

25. The multi-zone horseshoe pad of claim 1, wherein the pad is composed of or includes a polymeric material or a polyurethane or an elastomeric material.
